(19) United States
(12) Patent Application Publication
(10) Pub. No.: US 2026/0271901 A1
(43) Pub. Date: Sep. 17, 2026

(54) INTERACTIVE CONTROL MODULE FOR INTELLIGENT FISHING REEL, AND INTELLIGENT FISHING REEL

(71) Applicant: Piscisea Tech Inc, Austin, TX (US)

(72) Inventors: Shengxu Cai, Shenzhen (CN); Chaoning Huang, Shenzhen (CN); Saier Wu, Shenzhen (CN); Bingyao Tang, Hepu County (CN)

(21) Appl. No.: 19/230,590

(22) Filed: Jun. 6, 2025

(30) Foreign Application Priority Data
Mar. 11, 2025 (CN) 202520431689.7

(51) Int. Cl. A01K 89/015; A01K 89/017; G05B 15/02

(52) U.S. Cl. CPC A01K 89/0178; A01K 89/017; A01K 89/0184; G05B 15/02

(57) ABSTRACT

Disclosed is an interactive control module for an intelligent fishing reel, including a host mainboard, a grip knob module, a switch module, a battery module, a display module, and a sensing module. The battery module is electrically connected to the host mainboard, the grip knob module, the switch module, the display module, and the sensing module. The sensing module is connected to the grip knob module, the switch module is connected to the grip knob module and the host mainboard, and the host mainboard is further connected to the grip knob module. In the interactive control module for an intelligent fishing reel, the grip knob module is arranged, the host mainboard, the switch module, and the sensing module are arranged on the grip knob module, and sensing control and switch control buttons are arranged on the grip knob module.

### CROSS REFERENCE TO RELATED APPLICATIONS

The present disclosure claims the priority of Chinese Patent Application No. 202520431689.7 filed on Mar. 11, 2025, the content of which is incorporated herein by reference in its entirety.

### TECHNICAL FIELD

The present disclosure belongs to the technical field of intelligent fishing reels, and specifically relates to an interactive control module for an intelligent fishing reel, and an intelligent fishing reel.

### BACKGROUND

With the advancements in technology, fishing devices have been progressively intelligentized. Electric fishing reels, as novel fishing reels that are motor-driven to achieve automatic line retrieval, demonstrate immense potential in enhancing fishing efficiency and experience. An electric fishing reel not only simulates bait movement to attract fish, but also provides the user with more convenience through an integrated control system.

An intelligent fishing reel currently available on the market is typically provided with an integrated interaction module, and the module includes functional components such as a display screen, a switch button, and a mode selection button. The display screen shows information such as a battery level, a line retrieval speed, sensitivity, and a current fishing mode; the switch button is configured for powering the fishing device on or off; and the mode selection button allows the user to easily switch between different preset sensitivity settings and fishing modes. Additionally, the fishing reel further includes a control module consisting of a control chip, and the control module is configured to receive data from the interaction module and adjust the operating state accordingly.

Intelligent fishing reels of the prior art significantly enhance user experience, but during interaction with an intelligent fishing reel, the user, due to scattered distribution of control components, needs to frequently search for and operate various separate switches, which increases operation difficulty and complexity, thereby causing operation inconvenience.

### SUMMARY

An objective of the present invention is to provide an interactive control module for an intelligent fishing reel, and an intelligent fishing reel, so as to solve the technical problems mentioned in the above Background.

In order to achieve the above objective, the present disclosure provides the following technical solution: an interactive control module for an intelligent fishing reel, including a grip knob module, as well as a host mainboard, a switch module, and a sensing module arranged on the grip knob module, where the host mainboard is further connected to the grip knob module, such that the grip knob module receives signals from both the switch module and the sensing module and forwards the signals to the host mainboard; and both the grip knob module and the host mainboard are connected to a battery module, the sensing module is connected to the grip knob module, and the switch module is connected to both the grip knob module and the host mainboard.

Preferably, the grip knob module includes a housing, and the housing is designed to be either spindle-shaped or fusiform-shaped to facilitate grip and force application.

Preferably, the switch module includes a fishing reel mode switch, a shutter switch, and a motor trigger switch, and the fishing reel mode switch, the shutter switch, and the motor trigger switch are all connected to the grip knob module and output switch status signals to the grip knob module.

Preferably, the switch module further includes a gear ratio switch and a power switch, and both the gear ratio switch and the power switch are connected to the host mainboard and output switch status signals to the host mainboard.

Preferably, the sensing module includes a rocker arm pressure sensor, and the rocker arm pressure sensor is connected to the grip knob module.

Preferably, the battery module includes a first battery and a second battery, the first battery is connected to the grip knob module, the power switch, and a Type-C charging port, and the second battery is connected to a field-oriented control (FOC) module and a battery eliminator circuit (BEC) module, where the second battery is connected to the host mainboard through FOC, and the second battery is connected to the first battery through BEC.

Preferably, the host mainboard is further connected to a display module, and the display module is configured to receive and display data processed by the host mainboard.

Preferably, the host mainboard is further connected to an eyewear data interface, and the host mainboard is connected to a head-mounted device through the eyewear data interface.

Preferably, the host mainboard is further connected to an action camera, and the shutter switch controls activation and deactivation of the action camera through the grip knob module and the host mainboard.

An intelligent fishing reel is provided, and the intelligent fishing reel includes the above interactive control module for an intelligent fishing reel.

The present disclosure has the following beneficial effects and advantages: the interactive control module for an intelligent fishing reel, including the intelligent fishing reel, differs from an interaction module of the prior art, the grip knob module is arranged, the host mainboard, the switch module, and the sensing module are arranged on the grip knob module, and sensing control and switch control buttons are arranged on the grip knob module, such that the user operates the switch module and the sensing module solely through the grip knob module, which reduces the operation difficulty and complexity. Additionally, cooperation of the grip knob module and the host mainboard achieves rapid signal transmission and processing, enhances the interaction intelligence, and makes the overall operation simpler and more convenient.

### BRIEF DESCRIPTION OF THE DRAWINGS

FIG. 1 is a schematic structural diagram of the present disclosure.

FIG. 2 is a schematic diagram of structural connection of the present disclosure.

Reference numerals in the figures: 1—grip knob module; 2—host mainboard; 3—switch module; 4—sensing module; 5—battery module; and 6—display module.

### DETAILED DESCRIPTIONS OF THE EMBODIMENTS

The technical solutions in the examples of the present disclosure will be clearly and completely described below in combination with the accompanying drawings in the examples of the present disclosure. Apparently, the examples described are merely some rather than all of the examples of the present disclosure. Based on the examples of the present disclosure, all other examples obtained by those of ordinary skill in the art without making creative efforts shall fall within the protection scope of the present disclosure.

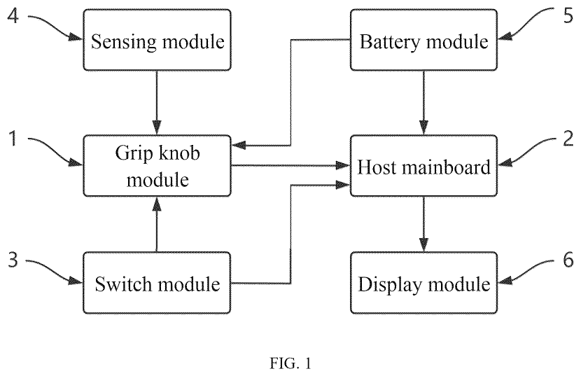

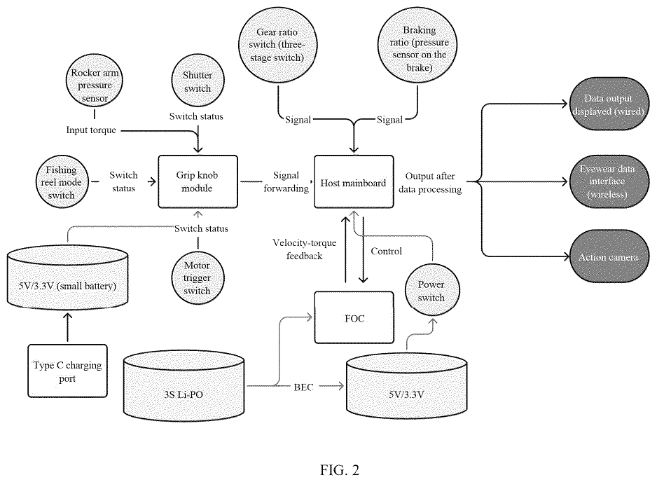

With reference to FIGS. 1-2, an interactive control module for an intelligent fishing reel includes a grip knob module 1, as well as a host mainboard 2, a switch module 3, and a sensing module 4 arranged on the grip knob module 1, where the host mainboard 2 is further connected to the grip knob module 1, such that the grip knob module 1 receives signals from both the switch module 3 and the sensing module 4 and forwards the signals to the host mainboard 2. The grip knob module 1 includes a housing, and the housing is designed to be either spindle-shaped or fusiform-shaped to facilitate grip and force application, but a shape of the housing is not limited to the spindle shape or the fusiform shape. The housing is designed to facilitate grip and force application, which accords with natural habits of gripping with hands, and minimizes fatigue during prolonged use. Additionally, the grip knob module 1 integrates functional assemblies for signal reception and preliminary processing, rapidly responds to signals from the switch module 3 and the sensing module 4, and forwards them to the host mainboard 2 in a timely manner. Both the grip knob module 1 and the host mainboard 2 are connected to a battery module 5, the battery module 5 achieve system-wide power supply, the sensing module 4 is connected to the grip knob module 1 and sends signals to the grip knob module 1 after sensing, and the switch module 3 is connected to both the grip knob module 1 and the host mainboard 2 to achieve separate control over the grip knob module 1 and the host mainboard 2, where the host mainboard 2 serves as a central processing unit of the entire intelligent fishing reel and is configured for data reception, processing, and command issuance.

The switch module 3 includes a fishing reel mode switch, a shutter switch, and a motor trigger switch, where the fishing reel mode switch is configured to switch operational modes of the fishing reel, such as a leisure mode, a manual mode, and an electric assist mode, the motor trigger switch is configured to control starting and stopping of a fishing reel motor, adjust a rotational speed of the motor, and precisely control a speed of line release and retrieval, and the fishing reel mode switch, the shutter switch, and the motor trigger switch are all connected to the grip knob module 1 and output switch status signals to the grip knob module 1.

The switch module 3 further includes a gear ratio switch and a power switch, where the gear ratio switch is configured to adjust a gear ratio of the fishing reel according to actual fishing conditions, such as fish sizes and water velocity, so as to achieve more efficient line release and retrieval. The gear ratio switch is a three-stage switch, the power switch controls startup and shutdown of the entire intelligent fishing reel system. When the power switch is pressed, the battery module 5 supplies power to the entire system, the host mainboard 2 is initialized, all modules enter an operating state, and both the gear ratio switch and the power switch are connected to the host mainboard 2 and output switch status signals to the host mainboard 2.

The sensing module 4 includes a rocker arm pressure sensor, the rocker arm pressure sensor is connected to the grip knob module 1, and the rocker arm pressure sensor is arranged to facilitate control over the grip knob module 1 with hands, and controls the motor to output variable power according to the pressure detected.

The host mainboard is further connected to a brake pressure sensor, and the brake pressure sensor accurately measures the pressure applied during braking in real time and displays the pressure in the form of percentage.

The battery module 5 includes a first battery and a second battery, and the first battery is connected to the grip knob module 1, the power switch, and a Type-C charging port, where the first battery is charged via the Type-C port and provides a stable power supply to the grip knob module 1 and the power switch, such that the grip knob module 1 continuously receives and processes signals and the power switch normally controls the startup and shutdown of the system, where a voltage of the first battery is typically 5V/3.3V. The second battery is connected to a field-oriented control (FOC) module and a battery eliminator circuit (BEC) module, where the second battery is connected to the host mainboard 2 through FOC, the second battery is connected to the first battery through BEC, and the second battery is a 3S Li—PO lithium polymer battery that primarily supplies power to FOC and BEC. The second battery is connected to the host mainboard 2 through FOC for power supply thereto and ensures stable operation of the host mainboard 2, and is connected to the first battery through BEC to achieve voltage conversion and rational power distribution, thereby ensuring system-wide stable power supply.

Further, the dual-battery design and reasonable connection of the battery module 5 achieve efficient power distribution and stable power supply. The first battery supplies power to commonly used control modules (i.e., the grip knob module 1, the switch module 3, the sensing module 4, and the display module 6), and the second battery supplies power to critical drive and control modules (i.e., the host mainboard 2, FOC, and BEC), which ensures stable operation of the entire intelligent fishing reel system in various complex environments and avoids equipment failures caused by power instability.

The host mainboard 2 is further connected to a display module 6, the display module 6 is configured to receive and display data processed by the host mainboard 2, and the display module 6 receives processed data from the host mainboard 2 in real time, such as the operational mode, gear ratio stage, rocker arm pressure, battery level, and other information of the fishing reel. Such data are displayed in an intuitive manner, which helps the user to understand an operating state of the fishing reel instantaneously and effortlessly.

The host mainboard 2 is further connected to an eyewear data interface, and the host mainboard 2 is connected to a head-mounted device through the eyewear data interface. The host mainboard 2 is connected to a head-mounted device through the eyewear data interface, such as smart glasses. The user is allowed to directly view relevant data of the fishing reel through the head-mounted device without need to look down at the display module 6, thereby enhancing convenience and safety during use. Additionally, the head-mounted device receives voice prompts from the host mainboard 2, such as a fish bite prompt and a low battery warning, which enables the user to stay more focused on the fishing process.

Preferably, the host mainboard 2 is further connected to an action camera, and the shutter switch controls activation and deactivation of the action camera through the grip knob module 1 and the host mainboard 2. The action camera is capable of recording the entire fishing process, thereby enabling the user to keep cherished memories, and the shutter switch is mounted on the grip knob module 1, which facilitates real-time control of the action camera.

An intelligent fishing reel is provided, and the intelligent fishing reel includes the above interactive control module for an intelligent fishing reel.

The interactive control module for an intelligent fishing reel and the intelligent fishing reel collect various operational and environmental signals through the sensing module 4 and the switch module 3, and transmit them via the grip knob module 1 to the host mainboard 2 for processing, and the host mainboard 2 analyzes these signals to understand the user's operational intentions and the current fishing environment.

Finally, it should be noted that the above is only a preferred example of the present disclosure, and is not intended to limit the present disclosure. Although the present disclosure has been described in detail with reference to the above embodiment, for those skilled in the art, it is still apparent that the technical solutions described in the above embodiment may be modified, or some technical features thereof may be equivalently replaced. Any modifications, equivalent replacements, improvements, etc. made within the spirit and principles of the present disclosure shall fall within the protection scope of the present disclosure.

What is claimed is:

1. An interactive control module for an intelligent fishing reel, comprising a grip knob module, as well as a host mainboard, a switch module, and a sensing module arranged on the grip knob module, wherein the host mainboard is further connected to the grip knob module, such that the grip knob module receives signals from both the switch module and the sensing module and forwards the signals to the host mainboard; and both the grip knob module and the host mainboard are connected to a battery module, the sensing module is connected to the grip knob module, and the switch module is connected to both the grip knob module and the host mainboard.

2. The interactive control module for an intelligent fishing reel according to claim 1, wherein the grip knob module comprises a housing, and the housing is designed to be either spindle-shaped or fusiform-shaped to facilitate grip and force application.

3. The interactive control module for an intelligent fishing reel according to claim 1, wherein the switch module comprises a fishing reel mode switch, a shutter switch, and a motor trigger switch, and the fishing reel mode switch, the shutter switch, and the motor trigger switch are all connected to the grip knob module and output switch status signals to the grip knob module.

4. The interactive control module for an intelligent fishing reel according to claim 3, wherein the switch module further comprises a gear ratio switch and a power switch, and both the gear ratio switch and the power switch are connected to the host mainboard and output switch status signals to the host mainboard.

5. The interactive control module for an intelligent fishing reel according to claim 1, wherein the sensing module comprises a rocker arm pressure sensor, and the rocker arm pressure sensor is connected to the grip knob module.

6. The interactive control module for an intelligent fishing reel according to claim 1, wherein the battery module comprises a first battery and a second battery, the first battery is connected to the grip knob module, the power switch, and a Type-C charging port, and the second battery is connected to a field-oriented control (FOC) module and a battery eliminator circuit (BEC) module, wherein the second battery is connected to the host mainboard through FOC, and the second battery is connected to the first battery through BEC.

7. The interactive control module for an intelligent fishing reel according to claim 1, wherein the host mainboard is further connected to a display module, and the display module is configured to receive and display data processed by the host mainboard.

8. The interactive control module for an intelligent fishing reel according to claim 1, wherein the host mainboard is further connected to an eyewear data interface, and the host mainboard is connected to a head-mounted device through the eyewear data interface.

9. The interactive control module for an intelligent fishing reel according to claim 1, wherein the host mainboard is further connected to an action camera, and the shutter switch controls activation and deactivation of the action camera through the grip knob module and the host mainboard.

10. An intelligent fishing reel, comprising the interactive control module for an intelligent fishing reel according to claim 1.
